(19) United States
(12) Patent Application Publication
(10) Pub. No.: US 2022/0328915 A1
(43) Pub. Date: Oct. 13, 2022

(54) Resin composition and flame-resistant structure and battery package including the same

(71) Applicant: Industrial Technology Research Institute, Hsinchu (TW)

(72) Inventors: Jiou-You LIOU, Changhua County (TW); Tsao-Ming PENG, Hsinchu County (TW)

(21) Appl. No.: 17/478,802

(22) Filed: Sep. 17, 2021

(30) Foreign Application Priority Data
Apr. 8, 2021 (TW) 110112695

(51) Int. Cl. H01M 50/143; C08K 13/02; C09K 5/14; C09K 21/02; H01M 50/122; H01M 10/655

(52) U.S. Cl. CPC H01M 50/143; C08K 13/02; C09K 5/14; C09K 21/02; H01M 50/122; H01M 10/655; C08K 2201/014; C08K 5/3445

(57) ABSTRACT

A resin composition, a flame-resistant structure and a battery package are provided. The resin composition includes a resin, a crystalline hydrate, and urea, wherein the weight ratio of crystalline hydrate to resin to urea is 6:1.5-5:1.2-3. The flame-resistant structure includes a body. The body includes a cured resin composition. The resin composition includes a resin, a crystalline hydrate, and urea, wherein the weight ratio of crystalline hydrate to resin to urea is 6:1.5-5:1.2-3. The battery package includes a battery and the flame-resistant structure.

### CROSS REFERENCE TO RELATED APPLICATIONS

This application claims priority of Taiwan Patent Application No. 110112695, filed on Apr. 8, 2021, the entirety of which is incorporated by reference herein.

### TECHNICAL FIELD

The present disclosure relates to a curable resin composition and a flame-resistant structure and a battery package including the same.

### BACKGROUND

Nowadays, lithium batteries are widely used in electronic devices such as electric vehicles and 3C products because of high energy storage capacity and low manufacturing cost. In order to provide sufficient energy, electrical bicycles, electrical motorcycles, electrical heavy motorcycle, and pure electrical cars need batteries with a battery capacity of about 0.54 kWh (equivalent to the energy of 6.5 kg of TNT), batteries with a battery capacity of about 1-2 kWh, batteries with a battery capacity of about 20 kWh, and batteries with a battery capacity of about 60-100 kWh, respectively. Further, in order to achieve efficient space utilization, the batteries are arranged close to each other. Therefore, heat dissipations of the batteries are poor, and damages caused by the thermal runaway of the batteries may be severe. The security risk of the batteries is high.

Currently, a Battery Management System (BMS) is used to monitor the temperature and current of the batteries to prevent the thermal runaway of the battery cells of the batteries. The BMS disconnects a circuit of the battery cells before an open flame presented in the battery cells. Therefore, the thermal runaway of the battery cells could be prevented. However, high temperature indicates that there is a short circuit inside the battery cells. The short circuit inside the battery cells will melt separators in the battery cells, which will lead to a large number of chemical reactions. The above chemical reactions are chemical chain reactions. Once free radicals are formed, the free radicals will begin chemical chain reactions. It is difficult to stop the chemical chain reactions. The chemical chain reactions will conduct until electrolytes in the batteries are fully consumed. In addition, when the batteries are subjected to external impacts, punctures and crushing, the BMS will be failure. Therefore, the BMS cannot monitor the temperature and current of the batteries. The thermal runaway of the battery cells cannot be prevented.

Currently, in commercially available battery products, the batteries are encased by engineering plastics (such as PP/PC and PC/ABS) including a large amount of flame retardant. The batteries are non-combustible. Therefore, the thermal runaway of the battery cells could be prevented, and accidental combustions of the batteries caused by the thermal runaway of the battery cells could be solved. However, encasing the battery with engineering plastics including a large amount of flame retardant cannot extinguish a flame of burning batteries.

### SUMMARY

The present disclosure provides a curable resin composition, a flame-resistant structure formed of the curable resin composition, and a battery package including the flame-resistant structure.

An embodiment of the present disclosure provides a resin composition including a resin, a crystalline hydrate, and urea, wherein a weight ratio of the crystalline hydrate: the resin: the urea is 6:1.5-5:1.2-3.

The other embodiment of the present disclosure provides a flame-resistant structure including a body. The body includes a cured resin composition including a resin, a crystalline hydrate, and urea, wherein a weight ratio of the crystalline hydrate: the resin: the urea is 6:1.5-5:1.2-3.

In addition, an embodiment of the present disclosure provides a battery package including a battery and the flame-resistant structure mentioned above. The flame-resistant structure encases at least a portion of the battery.

### BRIEF DESCRIPTION OF THE DRAWINGS

The present disclosure can be more fully understood by reading the subsequent detailed description and examples with references made to the accompanying drawings, wherein:

FIGS. 1A to 1D show schematic diagrams of various bodies of the flame-resistant structure, which are formed of the cured resin compositions of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides a curable resin composition, a flame-resistant structure formed of the curable resin composition, and a battery package including the flame-resistant structure. The resin composition includes a large amount of crystalline hydrates. The battery package including the flame-resistant structure formed of the resin composition including a large amount of crystalline hydrate can extinguish the flame and suppress high temperature generated by a thermal runaway of a battery cell. Therefore, the spread of thermal runaway could be effectively suppressed, the safety of the battery product could be improved, and the risk of battery fire could be reduced.

Crystalline hydrates having an ability to release water at a suitable temperature are selected for cooling a system and extinguishing a flame in the system. However, the crystalline hydrates are acidic. Compositions including too much crystalline hydrates may not be cured. The present disclosure provides a resin composition including crystalline hydrates and urea. The cure inhibition of acidic substances (crystalline hydrates) is suppressed by urea. Accordingly, a curable resin composition that can extinguish flame and suppress high temperature, a flame-resistant structure formed of the same, and a battery package including the same are provided.

According to an embodiment, the present disclosure provides a resin composition including a resin, a crystalline hydrate, and a urea.

The resin may include a reactive resin that can be cured by a chemical reaction after mixing other components. In an embodiment, the resin may include thermosetting resins. The thermosetting resins could be cured to form a network structure to provide high rigidity, high hardness, high temperature resistance, and non-flammability. Resin compositions including the thermosetting resins are less likely to deform after a curing process, provide better temperature resistance and are less flammable. Therefore, the resin compositions including the thermosetting resins can provide a better thermal insulation effect. Examples of the resin include, but not limited to, an epoxy resin, an unsaturated resin, an acrylic resin, an amino resin, a phenol resin, a siloxane resin, or any combination thereof. In an embodiment, the resin may include an epoxy resin, an unsaturated resin, an acrylic resin, or any combination thereof. In an embodiment, the resin may include an epoxy resin, an unsaturated resin, or any combination thereof.

As used in the disclosure, “crystalline hydrates” means crystalline hydrates that release water when heated at a temperature above 100° C. The crystalline hydrates may include crystalline hydrates that release water when heated at a temperature between 100° C. and 180° C. In an embodiment, the crystalline hydrates may include crystalline hydrates that release water when heated at a temperature between 100° C. and 150° C. Crystalline hydrate that releases water when heated at a temperature above 100° C. are selected for avoiding water releasing from the crystalline hydrate during the subsequent curing process. In the view of the temperature of the thermal runaway of the battery cells, the resin composition for forming a heat resistant structure of a battery package including the crystalline hydrate that releases water when heated at a temperature of 180° C. or less can extinguish the flame and heat generated by failed battery cells effectively and instantly. Examples of crystalline hydrates may include, but not limited to, an ammonium aluminum sulfate, a magnesium chloride, a calcium chloride, a magnesium ammonium phosphate, a calcium nitrate tetrahydrate, an iron(III) nitrate nonahydrate, or any combination thereof. In an embodiment, the crystalline hydrates may include an ammonium aluminum sulfate, a magnesium chloride, a calcium chloride, or any combination thereof. In one embodiment, the crystalline hydrates may include an ammonium aluminum sulfate.

The resin composition may contain more crystalline hydrate than resin or urea by weight. Accordingly, the resin composition can release a large amount of water to provide better flame extinguishing effect and lower the temperature effectively. In an embodiment, the weight ratio of crystalline hydrate to resin may be 1.2:1 to 4:1, and the weight ratio of urea to crystalline hydrate may be 1:2 to 1:5. When the weight ratio of crystalline hydrate to resin is greater than 4:1 or the weight ratio of urea to crystalline hydrate is greater than 1:5, the resin composition may not be cured or may react incompletely during the subsequent curing process.

In an embodiment, the resin composition has a pH greater than 5. In an embodiment, the weight ratio of crystalline hydrate to resin to urea in the resin composition may be 6:1.5-5:1.2-3. The pH of the resin composition is adjusted to greater than 5 to prevent the resin composition from being difficult to cure due to the large amount of the crystalline hydrates. The resin composition can be cured smoothly during the subsequent curing process while the weight ratio of crystalline hydrate to resin to urea in the resin composition is 6:1.5-5:1.2-3. In an embodiment, the resin composition may further include a thermally conductive filler, a fiber, a curing agent, a curing initiator, a curing accelerator, or any combination thereof. By including a curing agent, a cure initiator, a cure promoter, or any combination thereof, the curing of the resin composition during the subsequent curing process may be ensured, and the time required for the subsequent curing process may be reduce.

In one embodiment, the resin composition may further include other functional additives for increasing structural strength or thermal conductivity of the resin composition. Examples of the functional additives may include thermally conductive fillers or fibers. The thermally conductive fillers may improve the heat dissipation function of the resin composition so that the cooling effect of the resin composition could be further improved. Examples of thermally conductive fillers may include, but not limited to, aluminum nitride, boron nitride, silicon carbide, magnesium oxide, carbon fibers, aluminum oxide, zinc oxide, or any combination thereof. In an embodiment, the thermally conductive filler may include carbon fibers, silicon carbide, aluminum oxide, or any combination thereof. The fibers may increase the structural strength of the cured resin composition. Examples of fibers may include, but not limited to, glass fibers, organic fibers, or any combination thereof.

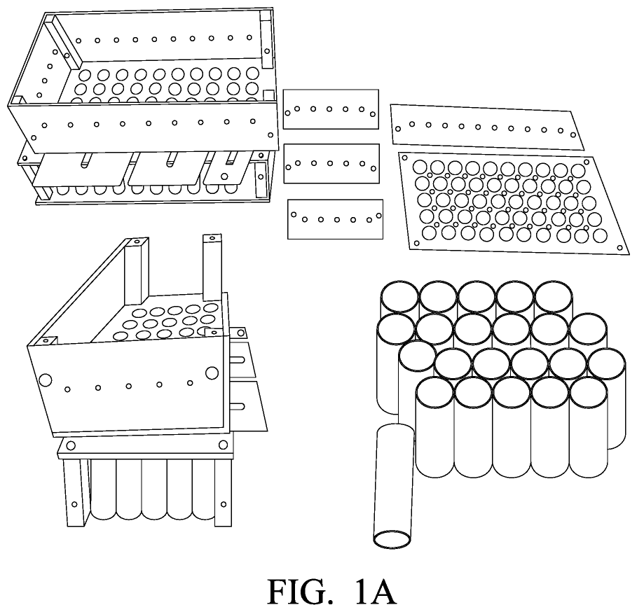

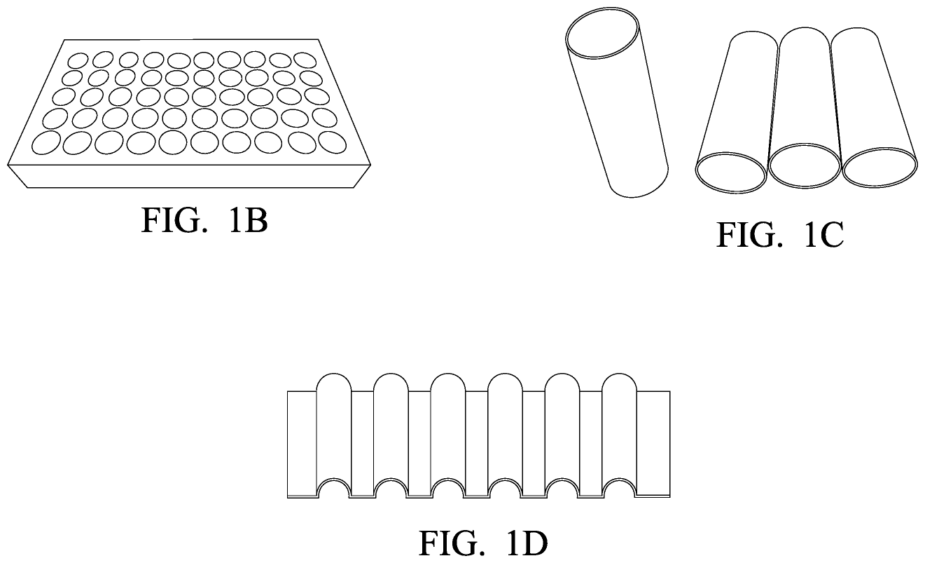

The present disclosure further provides a flame-resistant structure. The flame-resistant structure includes a body formed of the cured resin composition as mentioned above. A manufacturing method of the body of the flame-resistant structure includes steps of molding the resin composition into a desired shape and curing the molded resin composition. Processes for molding the resin composition includes, but not limited to, a casting process, a vacuum infusion process, a hand lay-up process, an extrusion process, a pultrusion process, an injection molding process, or any combination thereof. The resin composition may be molded into various shapes, for example, a cylinder shape. The resin composition may be molded by CNC machining. In an embodiment, the resin composition can be molded into the shape of a battery shell, a battery sleeve, a honeycomb battery holder, a waved separator, or any combination thereof. The molded resin composition may be cured to form a body including a battery shell, a battery sleeve, a battery holder, a separator, a honeycomb plate, or any combination thereof. In an embodiment, the body may include a battery shell, a battery sleeve, a battery holder, a separator, a honeycomb plate, or any combination thereof. FIGS. 1A to 1D show schematic diagrams of various bodies of the flame-resistant structure, which are formed of the cured resin compositions of the present disclosure. FIG. 1A shows a schematic diagram of an entire set of battery shell plates, FIG. 1B shows a schematic diagram of a honeycomb battery holder, FIG. 1C shows a schematic diagram of a battery sleeve, and FIG. 1D shows a schematic diagram of a waved separator.

Processes for curing resin compositions including, but not limited to, thermal curing processes, light curing processes, or combinations thereof.

In an embodiment, the flame-resistant structure may further include a thermally conductive member or a structural reinforcement in or on the body. In an embodiment, examples of the thermally conductive member may include, but not limited to, a thermally conductive silicone sheet, a ceramic sheet, a thermally conductive graphite sheet, a metal foil, a metal fin, or any combination thereof. In an embodiment, examples of structural reinforcement may include, but not limited to, carbon fibers, glass fibers, organic fibers (e.g., polyethylene fibers), or any combination thereof.

The present disclosure further provides a battery package including a battery and the flame-resistant structure mentioned above, wherein the flame-resistant structure encases at least a portion of the battery. By including the flame-resistant structure mentioned above, when a short circuit occurs inside the battery, the battery package provided in the present disclosure can release a large amount of water in real time to extinguish the flame and suppress the high temperature generated by the failed battery cells at the initial reaction stage before the chemical chain reaction. Therefore, the spread of thermal runaway could be effectively suppressed, the safety of the battery product could be improved, and the risk of battery fire could be reduced.

Examples of the resin compositions of the present disclosure and Comparative Example are provided below to further illustrate the advantages of the resin compositions of the present disclosure.

### Curability Assessment

### Example 1

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), 20 g of urea (CAS#: 57-13-6, Sigma-Aldrich), 60 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

### Example 2

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), 20 g of urea (CAS#: 57-13-6, Sigma-Aldrich), 50 g magnesium chloride (CAS#: 7786-30-3, Sigma-Aldrich) were added into a 250 ml glass container. A resin composition was formed after intensive mixing the components mentioned above.

### Example 3

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), 20 g of urea (CAS#: 57-13-6, Sigma-Aldrich), and 50 g of calcium chloride (CAS#: 10035-04-8, Sigma-Aldrich) were added into a 250 ml glass container. A resin composition was formed after intensive mixing the components mentioned above.

### Example 4

20 g of unsaturated resin (Distitron-120, Polynt), 0.2 g of bis(4-tert-butylcyclohexyl) peroxydicarbonate (BCHPC, Union Chemical), 20 g of urea (CAS#: 57-13-6, Sigma-Aldrich), 60 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

### Example 5

20 g of unsaturated resin (Distitron-120, Polynt), 0.2 g of methyl ethyl ketone peroxide (MEKPO, Epocone Chemicals), 0.04 g of cobalt salt (Epocone Chemicals), 20 g of urea (CAS#: 57-13-6, Sigma-Aldrich), 50 g of magnesium chloride (CAS#. 7786-30-3, Sigma-Aldrich) were added into a 250 ml glass container. A resin composition was formed after intensive mixing the components mentioned above.

### Comparative Example 1

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), 60 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

### Comparative Example 2

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), and 50 g of magnesium chloride (CAS#: 7786-30-3, Sigma-Aldrich) were added into a 250 ml glass container. A resin composition was formed after intensive mixing the components mentioned above.

### Comparative Example 3

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), and 50 g of calcium chloride (CAS#: 10035-04-8, Sigma-Aldrich) were added into a 250 ml glass container. A resin composition was formed after intensive mixing the components mentioned above.

### Comparative Example 4

22 g of bisphenol A type epoxy resin (NPEL-170, epoxy equivalent: 170 g/eq, Nanya Resin), 30 g of borax, 6 g of Laromin® C260 (active hydrogen equivalent: 60-90), 0.3 g of imidazole (C11z, Shikoku Chemicals), 40 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

### Comparative Example 5

20 g of unsaturated resin (Distitron-120, Polynt), 0.2 g of bis(4-tert-butylcyclohexyl) peroxydicarbonate (BCHPC, Union Chemical), 60 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

### Comparative Example 6

20 g of unsaturated resin (Distitron-120, Polynt), 0.2 g of methyl ethyl ketone peroxide (MEKPO, Epocone Chemicals), 0.04 g of cobalt salt (Epocone Chemicals), and 50 g of magnesium chloride (CAS#: 7786-30-3, Sigma-Aldrich) were added into a 250 ml glass container. A resin composition was formed after intensive mixing the components mentioned above.

### Comparative Example 7

20 g of unsaturated resin (Distitron-120, Polynt), 0.2 g of methyl ethyl ketone peroxide (MEKPO, Epocone Chemicals), 30 g of borax, 0.04 g of cobalt salt (Epocone Chemicals), and 30 g of magnesium chloride (CAS#: 7786-30-3, Sigma-Aldrich) were added into a 250 ml glass container. A resin composition was formed after intensive mixing the components mentioned above.

### Comparative Example 8

22 g of bisphenol A type epoxy resin (NPEL-170, epoxy equivalent: 170 g/eq, Nanya Resin), 6 g of Laromin® C260 (active hydrogen equivalent: 60-90), 0.3 g of imidazole (C11z, Shikoku Chemicals), 60 g of ammonium aluminum sulfate (NH₄Al(SO₄)₂.12H₂O, CAS#: 7784-26-1, Sigma-Aldrich), 20 g of melamine (CAS#: 108-78-1) were added into a 250 ml glass container. A resin composition was formed after intensive mixing the components mentioned above.

### Comparative Example 9

20 g of unsaturated resin (Distitron-120, Polynt), 0.2 g of bis(4-tert-butylcyclohexyl) peroxydicarbonate (BCHPC, Union Chemical), 20 g of urea (CAS#: 57-13-6, Sigma-Aldrich), 110 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

### Comparative Example 10

20 g of unsaturated resin (Distitron-120, Polynt), 0.2 g of bis(4-tert-butylcyclohexyl) peroxydicarbonate (BCHPC, Union Chemical), 10 g of urea (CAS#: 57-13-6, Sigma-Aldrich), 20 g of ammonium aluminum sulfate (NH₄Al(SO₄)₂.12H₂O, CAS#: 7784-26-1, Sigma-Aldrich) were added into a 250 ml glass container. A resin composition was formed after intensive mixing the components mentioned above.

The resin compositions of Examples 1-5 and Comparative Example 1-10 were molded and then heated at 150° C. or less to cure the molded resin compositions.

The mass of the main components, pH, and cured degree of the resin compositions of Examples 1-5 and Comparative Examples 1-10 are shown in Table 1 below.

TABLE 1

| | | | | Crystal- | | | |
|---|---|---|---|---|---|---|---|
| | | | | lization | | | |
| | Resin | Urea | Borax | Hydrate | Melamine | pH | Cured |
| Example 1 | 22 g | 20 g | 0 g | 60 g | 0 g | 7 | Y |
| Example 2 | 22 g | 20 g | 0 g | 50 g | 0 g | 6 | Y |
| Example 3 | 22 g | 20 g | 0 g | 50 g | 0 g | 6 | Y |
| Example 4 | 20 g | 20 g | 0 g | 60 g | 0 g | 7 | Y |
| Example 5 | 20 g | 20 g | 0 g | 50 g | 0 g | >6 | Y |
| Comparative | 22 g | 0 g | 0 g | 60 g | 0 g | <3 | N |
| Example 1 | | | | | | | |
| Comparative | 22 g | 0 g | 0 g | 50 g | 0 g | <3 | N |
| Example 2 | | | | | | | |
| Comparative | 22 g | 0 g | 0 g | 50 g | 0 g | <3 | N |
| Example 3 | | | | | | | |
| Comparative | 22 g | 0 g | 30 g | 40 g | 0 g | >6 | Y |
| Example 4 | | | | | | | |
| Comparative | 20 g | 0 g | 0 g | 60 g | 0 g | <4 | N |
| Example 5 | | | | | | | |
| Comparative | 20 g | 0 g | 0 g | 50 g | 0 g | <3 | N |
| Example 6 | | | | | | | |
| Comparative | 20 g | 0 g | 30 g | 30 g | 0 g | >6 | Y |
| Example 7 | | | | | | | |
| Comparative | 22 g | 0 g | 0 g | 60 g | 20 g | <4 | N |
| Example 8 | | | | | | | |
| Comparative | 20 g | 20 g | 0 g | 110 g | 0 g | <3 | N |
| Example 9 | | | | | | | |
| Comparative | 20 g | 10 g | 0 g | 20 g | 0 g | >6 | Y |
| Example 10 | | | | | | | |

As can be seen from Table 1 above, the resin composition cannot be cured when the pH of the resin composition is less than 4.

Flame-Resistance Assessment

The flame resistances of the cured resin compositions of Examples 1-5 and Comparative Examples 4, 7 and 10 (test piece size: 125×13×1.5 mm) are tested. The method used for testing the flame resistance of the cured resin compositions includes the following steps: 1. grapping one upper edge of a test piece and suspending the test piece vertically above a holder; 2. turning on a gas flame gun to dry burn for 1-2 seconds to confirm that the flame color is blue and the output is stable; 3. moving the flame to a lower edge of the test piece, touching the test piece with the flame, and start counting time when the flame touches the test piece; 4. removing the flame after flaming a region of the test piece for 10 seconds, and observing and recording the flame self-extinguishing time; 5. repeating steps 3 and 4 twice, so that the same region of the test piece will be flamed total 3 times, and recording the flame self-extinguishing time for each time. The burning process will be recorded by a video device in the case that the flame self-extinguishing time is too short to be observed. A flame self-extinguishing time will be obtained by slow playing back the video after the test is completed.

The cured resin compositions of Examples 1-5 and Comparative Examples 4, 7 and 10 were burned by a gas flame gun (GB-2001, Prince, Japan) three times at atmospheric conditions. The flame self-extinguishing time of the cured resin compositions of Examples 1-5 and Comparative Examples 4, 7 and 10 were observed and recorded by a video device. The results are shown in Table 2 below.

TABLE 2

| flame self-extinguishing time | 1^{st} | 2^{nd} | 3^{rd} |
|---|---|---|---|
| Example 1 | <1 sec | <1 sec | <1 sec |
| Example 2 | <1 sec | <1 sec | <1 sec |
| Example 3 | <1 sec | <1 sec | <1 sec |
| Example 4 | <1 sec | <1 sec | <1 sec |
| Example 5 | <1 sec | <1 se | <1 sec |
| Comparative | <1 se | <8 sec | <15 sec |
| Example 4 | | | |
| Comparative | <1 sec | <5 sec | <10 sec |
| Example 7 | | | |
| Comparative | <1 sec | <5 sec | <12 sec |
| Example 10 | | | |

As can be seen from Table 2, compared to the cured resin compositions of Examples 1 to 5, the cured resin compositions of Comparative Examples 4, 7, and 10 have longer flame self-extinguishing time, which indicates that the cured resin compositions of Comparative Examples 4, 7, and 10 cannot extinguish flames and lower the temperatures effectively.

Heat Conduction Simulation

The time required for each of the cured resin compositions of Examples 1-5 and Comparative Examples 4, 7, and 10 to reach 150° C. is detected by a heat conduction simulation experiment. The method used for the heat conduction simulation experiments are as follows.

The resin compositions of Examples 1-5 and Comparative Examples 4, 7, and 10 are molded into a battery sleeve and then heated at 150° C. or less to cure the molded resin composition sleeve.

A stainless steel was attached to the inside of each of the resin composition sleeves. Flaming the resin composition sleeve of Examples 1-5 and Comparative Examples 4, 7, and 10 by a gas flame gun (GB-2001, Prince, Japan) at atmospheric conditions. The temperature change of each stainless steel was measured by a TM-946 four-channel thermometer (Lutron). The times required for stainless steels in the resin composition sleeve of Examples 1-5 and Comparative Examples 4, 7, and 10 to reach 150° C. were recorded. The results are shown in Table 3 below.

TABLE 3

| | Time required for |
|---|---|
| | temperature to |
| | reach 150° C. |
| Example 1 | 40 sec |
| Example 2 | 39 sec |
| Example 3 | 34 sec |
| Example 4 | 42 sec |
| Example 5 | 42 sec |
| Comparative | 23 sec |
| Example 4 | |
| Comparative | 27 sec |
| Example 7 | |
| Comparative | 25 sec |
| Example 10 | |

As can be seen from Table 3, compared to the stainless steels in the resin composition sleeves of Comparative Examples 4, 7, and 10, the stainless steels in the resin composition sleeves of Examples 1 to 5 takes longer time to reach 150° C., which indicates that the resin composition sleeves of Examples 1 to 5 can suppress the high temperature generated by the failed battery cells effectively. Therefore, the spread of thermal runaway could be effectively suppressed.

Battery Puncture Test

A battery pack including a semi-closed battery holder made of the resin composition of Example 1 and six 18650 battery cells (NCR18650PF, Panasonic) assembled with the holder is provided as Example 1. A battery pack including a battery holder made of an engineering plastic and ten 18650 battery cells (5 battery cells in a row, two rows in total) encased by the holder in a small module is provided as Comparative Example 11. A battery pack including battery cells fixed on a holder made of a fiber-reinforced plastic (not encased and isolated by the holder) is provided as Comparative Example 12.

The test conditions were as follows: 18650 battery cells (NCR18650PF, Panasonic); needle diameter: 3 mm; speed: 10 mm/s; and half penetration depth. The process of battery failure was recorded by a video device.

Calculating the total number of undamaged battery cells in the battery packs of Example 1 and Comparative Examples 11 and 12. The results are shown in Table 4 below.

TABLE 4

| | Number of |
|---|---|
| | undamaged cells |
| Example 1 | 5 |
| Comparative | 0 |
| Example 11 | |
| Comparative | 3 |
| Example 12 | |

As can be seen from Table 4, compared to the battery pack of Comparative Examples 11 and 12, the battery pack of Example 1 has an ability to protect the battery from the flames and high temperature generated by the failed battery cells.

According to the experiment results mentioned above, it can be seen that the flame-resistant structure formed of the cured resin composition of the present disclosure can extinguish the flame and suppress high temperature generated by the failed battery cells effectively. Therefore, the spread of thermal runaway of the failed battery cells could be effectively suppressed. The battery package including the flame-resistant structure made of the cured resin composition of the present disclosure has high product safety.

The features of several embodiments of the present disclosure are outlined above so that a person having ordinary skill in the art to which the present disclosure belongs may more readily understand the point of view of embodiments of the present disclosure. A person having ordinary skill in the art to which the present disclosure belongs should understand that they can design or modify other processes and structures based on embodiments of the present disclosure to achieve the same purposes and/or advantages as the embodiments presented herein. A person having ordinary skill in the art of the present disclosure should also understand that such equivalent processes and structures are not depart from the spirit and scope of the present disclosure and various changes, substitutions and replacements may be made without departing from the spirit and scope of the present disclosure.

What is claimed is:

1. A resin composition, comprising:
a resin;
a crystalline hydrate; and
urea,
wherein a weight ratio of the crystalline hydrate to the resin to the urea is 6:1.5-5:1.2-3.

2. The resin composition as claimed in claim 1, wherein the resin composition has a pH greater than 5.

3. The resin composition as claimed in claim 1, wherein the resin comprises an epoxy resin, an unsaturated resin, an acrylic resin, an amino resin, a phenol resin, a siloxane resin, or any combination thereof.

4. The resin composition as claimed in claim 1, wherein the crystalline hydrate comprises an ammonium aluminum sulfate, a magnesium chloride, a calcium chloride, a magnesium ammonium phosphate, a calcium nitrate tetrahydrate, an iron(III) nitrate nonahydrate, or any combination thereof.

5. The resin composition as claimed in claim 1, further comprising a thermally conductive filler, a fiber, a curing agent, a curing initiator, a curing accelerator, or any combination thereof.

6. A flame-resistant structure, comprising:
a body, comprising a cured resin composition, and
the resin composition, comprising:
a resin;
a crystalline hydrate; and
urea,
wherein the weight ratio of the crystalline hydrate to the resin to the urea is 6:1.5-5:1.2-3.

7. The flame-resistant structure as claimed in claim 6, wherein the resin comprises an epoxy resin, an unsaturated resin, an acrylic resin, an amino resin, a phenol resin, a siloxane resin, or any combination thereof.

8. The flame-resistant structure as claimed in claim 6, wherein the crystalline hydrate comprises an ammonium aluminum sulfate, a magnesium chloride, a calcium chloride, a magnesium ammonium phosphate, a calcium nitrate tetrahydrate, an iron(III) nitrate nonahydrate, or any combination thereof.

9. The flame-resistant structure as claimed in claim 6, further comprising a thermally conductive filler, a fiber, a curing agent, a curing initiator, a curing accelerator, or any combination thereof.

10. The flame-resistant structure as claimed in claim 6, wherein the body comprises a battery shell, a battery sleeve, a battery holder, a separator, a honeycomb plate, or any combination thereof.

11. The flame-resistant structure as claimed in claim 6, further comprising a thermally conductive member or a structural reinforcement in or on the body.

12. A battery package, comprising:
a battery; and
the flame-resistant structure as claimed in claim 6, which encases at least a portion of the battery.

13. The battery package as claimed in claim 12, wherein the resin in the resin composition of the flame-resistant structure comprises an epoxy resin, an unsaturated resin, an acrylic resin, an amino resin, a phenol resin, a siloxane resin, or any combination thereof.

14. The battery package as claimed in claim 12, wherein the crystalline hydrate in the resin composition of the flame-resistant structure comprises an ammonium aluminum sulfate, a magnesium chloride, a calcium chloride, a magnesium ammonium phosphate, a calcium nitrate tetrahydrate, an iron(III) nitrate nonahydrate, or any combination thereof.

15. The battery package as claimed in claim 12, wherein the flame-resistant structure further comprises a thermally conductive filler, a fiber, a curing agent, a curing initiator, a curing accelerator, or any combination thereof.

16. The battery package as claimed in claim 12, wherein the body of the flame-resistant structure comprises a battery shell, a battery sleeve, a battery holder, a separator, a honeycomb plate, or any combination thereof.

17. The battery package as claimed in claim 12, wherein the flame-resistant structure further comprises a thermally conductive member or a structural reinforcement in or on the body.
